(19) United States
(12) Patent Application Publication
(10) Pub. No.: US 2010/0295997 A1
(43) Pub. Date: Nov. 25, 2010

(54) AUTOMATIC WHITE BALANCE SYSTEM AND METHOD THEREOF

(75) Inventor: CHIN-JUNG CHEN, Tainan County (TW)

Correspondence Address: J C PATENTS, 4 VENTURE, SUITE 250, IRVINE, CA, 92618, US

(73) Assignee: Himax Display, Inc., Tainan County (TW)

(21) Appl. No.: 12/469,146

(22) Filed: May 20, 2009

(51) Int. Cl. H04N 9/73

(52) U.S. Cl. 348/655; 348/E09.051

(57) ABSTRACT

An automatic white balance (AWB) system including a luminaire, a light sensing unit, an analog-to-digital converter, a control unit and a driving circuit is provided. In the AWB system of a projection apparatus, the suitable AWB method is applied. The light sensing unit includes a light sensor and a light sensing circuit. The light sensor is coupled to the light sensing circuit for sensing intensity of the color lights emitted from the luminaire, no matter what colors the color lights emitted from the luminaire are. The white balance of the color lights in the AWB system of the projection apparatus is automatically achieved with the light sensor instead of the color sensors. Therefore, the cost of the projection apparatus with the AWB system is reduced.

### BACKGROUND OF THE INVENTION

1. Field of the Invention

The present invention relates to a color light balance system, and more particularly to an automatic white balance (AWB) system with a light sensor and an AWB method thereof for reducing cost.

2. Description of Related Art

With advancement in projection display technology, there have been rapid development and significant breakthroughs in projection systems and equipment in recent years. Currently, there are three major types of projectors including cathode ray tubes (CRT), liquid crystal display panel (commonly referred to as liquid crystal projectors), and digital light source processors, wherein the liquid crystal projectors characterized by portability and easy adjustability are more commonly used by the public.

The liquid crystal projector has advantages of its small size, high definition display and high luminance cooperating with light emitting diodes (LEDs). The liquid crystal projector illuminates a liquid crystal display element with a white light, which is balance from the three colors such as a red light, a green light and a blue light, emitted from the LEDs, and projects the images displayed by the liquid crystal display element to a screen. Accordingly, the white balance is an important issue in the liquid crystal projector.

In general, the LEDs are process dependent, so that the color emitted from the LEDs often have little color shift. While the white light is balance from the three colors, such as the red, green, and blue lights, respectively having color shift, it is possible that the images displayed by the liquid crystal display element to the screen have significantly difference in practice. In order to maintain the suitable white balance in the liquid crystal projector, the changing of the colors emitted from the LEDs must be known, so as to compensate and control the LEDs according to the feedback, thereby achieving the white balance.

A conventional liquid crystal projector must have three color sensors to achieve the white balance. The three color sensors are respectively used to detect the color shift of the corresponding color, and thus the liquid crystal projector regulates the driving currents of the LEDs to achieve the white balance according to the detecting result. However, it spends much cost that the liquid crystal projector achieves the white balance by utilizing three color sensors. The expensive color sensors are undesirable for reducing cost, and a suitable white balance system is needed.

### SUMMARY OF THE INVENTION

Accordingly, the exemplary embodiments consistent with the present invention are directed to provide an automatic white balance (AWB) system with a light sensing unit and an AWB method thereof for reducing cost.

According to one exemplary embodiment consistent with the present invention, there is provided an AWB system including a luminaire, a light sensing unit, an analog-to-digital converter (A/D converter), a control unit and a driving circuit. The luminaire sequentially provides a plurality of color lights, wherein the color lights comprises a first color light and a second color light. The light sensing unit senses intensity of the color lights emitted from the luminaire, and outputting a first analog signal and a second analog signal, which are corresponding to the first and the second color lights, respectively. The A/D converter is coupled to the light sensing unit, for converting the first and the second analog signals to a first and a second digital signals, respectively. The control unit is coupled to the A/D converter for estimating a first offset of the first color light and a second offset of the second color light from a ratio of a first predetermine value and a second predetermine value, wherein the first and the second predetermine value are respectively corresponding to the first and the second color lights. The driving circuit is coupled to the control unit for driving the luminaire in response to the first and the second offsets to achieve AWB of the color lights.

According to one exemplary embodiment consistent with the present invention, there is provided an AWB method of an AWB system. The AWB method includes the following steps. (1) A plurality of color lights are provided by a luminaire, wherein the color lights comprises a first color light and a second color light. (2) The color lights are sensed through a light sensing unit for obtaining a first analog signal corresponding to the first color light and a second analog signal corresponding to the second color light. (3) The first and the second analog signals are converted to a first and a second digital signals, respectively, through an A/D converter. (4) A first offset of the first color light and a second offset of the second color light are estimated from a ratio of a first predetermine value and a second predetermine value through a control unit, wherein the first and the second predetermine value are respectively corresponding to the first and the second color lights. (5) The luminaire is driven in response to the first and the second offsets through a driving circuit. Accordingly, the AWB of the first and the second color lights is achieved. It is noted that the order of the above steps is not used to limit the scope of the present invention.

In an embodiment of the present invention, the light sensing unit further includes a light sensor and a light sensing circuit. The light sensor senses intensity of the color lights emitted from the luminaire. The light sensing circuit is coupled to the light sensor and the A/D converter for outputting the first analog signal and the second analog signal, which are corresponding to the first and the second color lights, respectively.

In the AWB system of a projection apparatus, the suitable AWB method is applied. The AWB system with the light sensor coupled to the light sensing circuit according to one exemplary embodiment consistent with the present invention is different from the conventional system with the color sensors. With the light sensor instead of the color sensors, the white balance of the color lights in the AWB system of the projection apparatus is achieved. Therefore, the cost of the projection apparatus with the AWB system is reduced.

In order to make the features of the present invention comprehensible, exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate exemplary embodiments consistent with the present invention, and together with the description, serve to explain the principles of the invention.

FIG. 1 is a block diagram of an AWB system according to one exemplary embodiment consistent with the present invention.

FIG. 2 illustrates a liquid crystal projector (LCP) with the AWB system of FIG. 1.

FIG. 3 is a flowchart of an AWB method according to one exemplary embodiment consistent with the present invention.

FIG. 4 is a flowchart of a method related to obtain the first, second and third predetermined values in the above-described embodiment.

FIG. 5 illustrates a LCP with the AWB system of FIG. 1 according to one exemplary embodiment consistent with the present invention.

### DESCRIPTION OF EMBODIMENTS

The expansive color sensors are undesirable. Therefore, a suitable AWB system and an AWB method thereof are needed, and the exemplary embodiments consistent with the present invention are directed to provide an AWB system and an AWB method thereof for reducing cost.

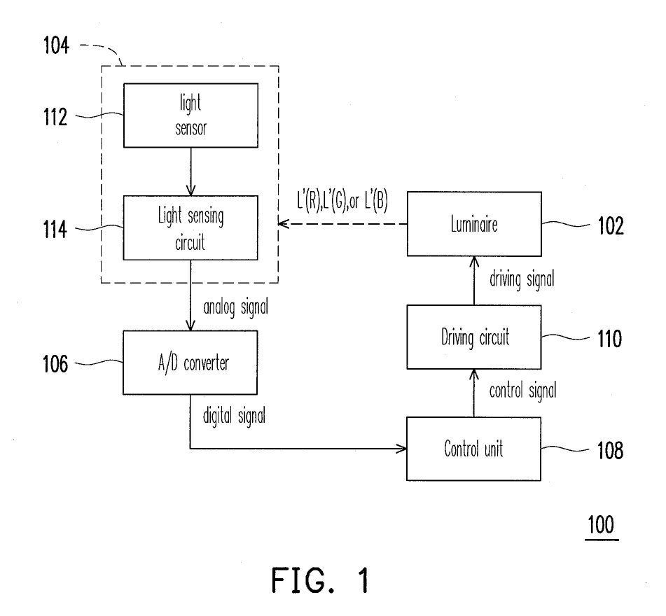

FIG. 1 is a block diagram of an AWB system according to one exemplary embodiment consistent with the present invention. Referring to FIG. 1, the AWB system 100 includes a luminaire 102, a light sensing unit 104, an analog-to-digital converter (A/D converter) 106, a control unit 108, and a driving circuit 110. Herein, the luminaire 102, for example, is a light emitting diode luminaire (an LED luminaire). Besides, the light sensing unit 104 further includes a light sensor 112 for sensing intensity of beams emitted from the LEDs in the present embodiment and a light sensing circuit for outputting an analog signal corresponding to the sensed color beam.

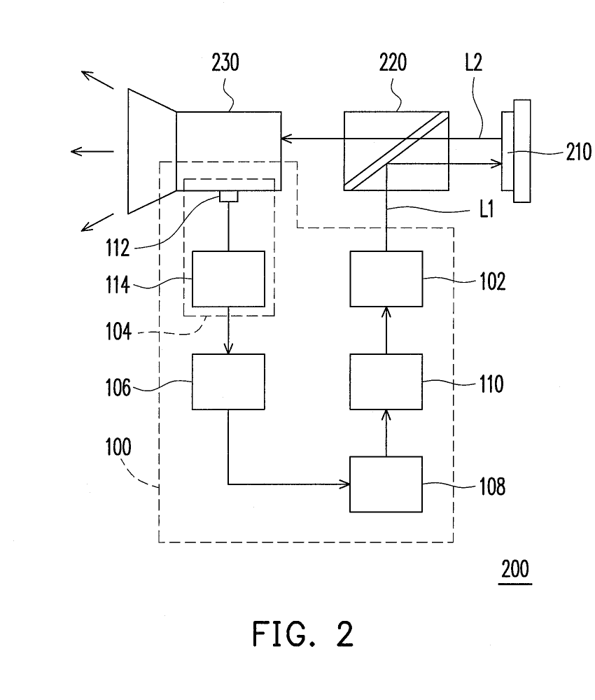

FIG. 2 illustrates a liquid crystal projector (LCP) with the AWB system of FIG. 1. Referring to FIG. 2, the LCP 200 includes the AWB system 100, a micro display panel 210, a total internal reflection prism 220 (TIR prism), and a projection lens 230. It should be noted that the LCP 200, such as a liquid crystal on silicon projector, having the AWB system 100 is exemplary, but it does not limit the scope of the present invention.

Referring to FIG. 2, the LCP 200 projects a user-desired image to a screen (not shown) with a color sequential method, for example. The LED luminaire 102 is suitable for providing an illumination beam L1, which is red, green or blue. The micro display panel 210 is disposed on the transmission path of the illumination beam L1. The micro display panel 210 is suitable for converting the illumination beam L1 into an image beam L2, and then the image beam L2 is reflected to the projection lens 230 through the TIR prism 220. Thereafter, the projection lens 230 projects the image beam L2 onto the screen (not shown). People ordinarily skilled in the art should know the basic operation of the LCP 200, and the detail is not described more than what is needed herein.

For good display quality, the white balance is an important issue in the above-mentioned LCP. In the present embodiment, the AWB system 100 with the light sensing unit 104 executes an AWB method to ensure display quality of the LCP 200.

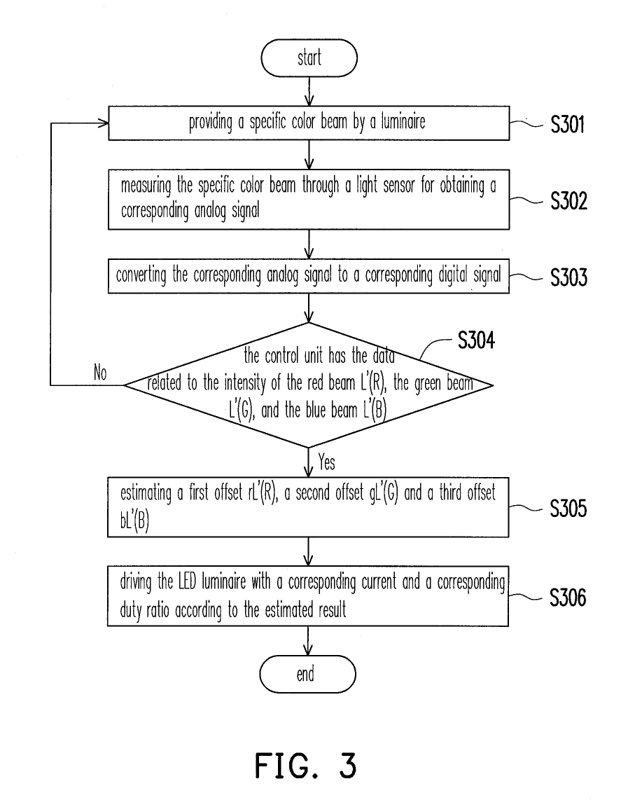

FIG. 3 is a flowchart of an AWB method according to one exemplary embodiment consistent with the present invention. Referring to FIGS. 1-3, the LED luminaire 102 is suitable for providing the illumination beam L1, which is red, green or blue. First, the driving circuit 110 drives the LED luminaire 102 to emit the red beam with a maximum brightness in step S301. In the present embodiment, the driving circuit 110 drives the LED luminaire 102 with a PWM light modulation method, which utilizes a constant current to drive the LEDs in the luminaire 102, and achieves the purpose of adjusting the brightness by using the duty ratio for turning on and turning off the LEDs. Herein, while the LED luminaire 102 emits the red beam with the maximum brightness, the driving circuit 110 drives the LED luminaire 102 by a driving signal Drv_R with the duty ratio about 80%, for example. In the other embodiment, the driving circuit 110 can drive the LED luminaire 102 with an analog modulation method is to adjust the brightness through changing a current flowing through the LEDs in the luminaire 102.

In the meanwhile, the micro display panel 210 having a white input pattern reflects the red beam with the maximum brightness to the projection lens 230 through the TIR prism 220. Then, the light sensing unit 104 measures the intensity of the red beam L′(R) with the maximum brightness through the light sensor 112, and then the light sensing unit 104 outputs a first analog signal corresponding to the red beam to the A/D converter 106 through the light sensing circuit 114 in step S302. Thereafter, the A/D converter 106 coupled to the light sensing unit 104 converts the first analog signal to a first digital signal, and outputs the first digital signal to the control unit 108 in step S303.

In the present embodiment, the control unit 108 will register the data related to the intensity of the red beam L′(R) after receiving the first digital signal. If the control unit 108 only has the data related to the intensity of the red, green, or blue beams, the LED luminaire 102 will be determined to change the color of the emitted beam in step S304, and the flow will return to step S301. For example, the control unit 108 only has the data related to the intensity of the red beam L′(R), and thus the LED luminaire 102 will be changed to emit the green beam in step S301. The loop of steps S301 and S304 is repeated until the control unit 108 has the data related to the intensity of the red beam L′(R), the green beam L′(G), and the blue beam L′(B).

After that, the control unit 108 estimate a first offset rL′(R), a second offset gL′(G) and a third offset bL′(B) in step S305. In the present embodiment, the control unit 108 estimates the three offsets rL′(R), gL′(G) and bL′(B) from the following equation:

$$\frac{L ( R )}{{L}^{′} ( R ) - {rL}^{′} ( R )} = \frac{L ( G )}{{L}^{′} ( G ) - {gL}^{′} ( G )} = \frac{L ( B )}{{L}^{′} ( B ) - {bL}^{′} ( B )} \qquad ( 1 )$$

wherein L(R) is a first predetermine value, L(G) is a second predetermine value, L(B) is a third predetermine value, L′(R) is the intensity of the red beam, L′(G) is the intensity of the green beam, L′(B) is the intensity of the blue beam, rL′(R) is the first offset, gL′(G) is the second offset and bL′(B) is the third offset. Besides, the intensity of the three beams L′(R), L′(G), and L′(B) are respectively measured by the light sensor 112 coupled to the light sensing circuit 114 in step S302. And, as known from the equation (1), one of the values r, g and b is zero, and once the zero value r, g or b is found, the other two values are negative.

After estimating, the control unit 108 gets the three offsets rL′(R), gL′(G) and bL′(B) from the equation (1). In step S306, according to the estimated result, the driving circuit 110 drives the LED luminaire 102 with the PWM light modulation method, which utilizes a modified constant current and a modified duty ratio to drive the LEDs in the luminaire 102, under the control of the control unit 108.

For example, according to the estimated result, the driving current is modified to a corresponding current, and the duty ratio of the driving signal Drv_R is 80% in the meanwhile. As a result, the driving circuit 110 drives the LED luminaire 102 by the modified driving signal Drv_R′ with the modified duty ratio about 80%+80%×r. Similarly, the driving circuit 110 respectively drives the LED luminaire 102 by the modified driving signal Drv_G′ with the modified duty ratio about 80%+80%×g and the modified driving signal Drv_B′ with the modified duty ratio about 80%+80%×b. Accordingly, the intensity of the red, green, and blue beams measured by light sensor 112 are satisfying to the equation (1). In the other embodiments, the duty ratio of the driving signal Drv_R, Drv_G and Drv_B may be about 90%, 70%, and etc.

As a result, the ratio of the current intensity of the red, green and blue beams is equal to the ratio of the first, second and third predetermined values L(R), L(G) and L(B), and the purpose of the white balance in the LCP 200 is achieved by using the AWB method of the AWB system in the present embodiment. Compared with the conventional LCP having three color sensors, which are respectively used to detect the color shift of the corresponding color, the LCP 200 in the present embodiment utilizes the light sensor 112 for sensing intensity of the beams emitted from the LEDs, no matter what colors of the beams emitted from the LEDs are. Accordingly, the LCP 200 utilizing the light sensor 112 to achieve the purpose of the white balance has lower coat than the conventional LCP having three color sensors. The following embodiment related to obtain the first, second and third predetermined values L(R), L(G) and L(B) will be described.

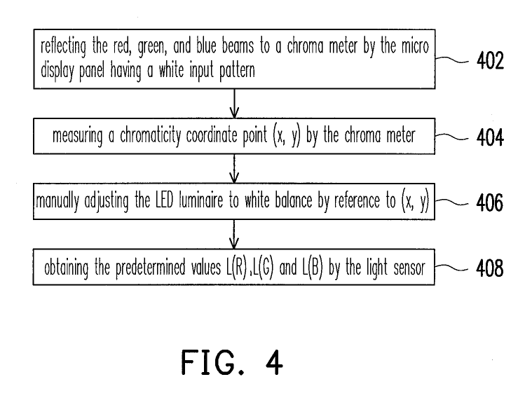

FIG. 4 is a flowchart of a method related to obtain the first, second and third predetermined values in the above-described embodiment. A model LCP is used for obtaining the first predetermined values L(R), second predetermined values L(G) and third predetermined values L(B). The model LCP has all the same design as the mass-produced LCP (i.e. the LCP 200 in the FIG. 2). Referring to FIGS. 2 and 4, in order to obtain the first, second and third predetermined values L(R), L(G) and L(B), there is an optical measurement instrument, such as a chroma meter (not shown), disposed on the transmission path of the image beam L2 in the model LCP. In step S402, the LED luminaire 102 of the model LCP emits the red, green, and blue beams with a maximum brightness at the same time. Meanwhile, the micro display panel 210 of the model LCP having a white input pattern reflects the red, green, and blue beams to the chroma meter. Then, a chromaticity coordinate point (x, y) is measured by the chroma meter in step S404. Thereafter, in step S406, the LED luminaire 102 of the model LCP is manually adjusted to white balance by reference to the chromaticity coordinate point (x, y) measured by the chroma meter in step S404. Accordingly, the first, second and third predetermined values L(R), L(G) and L(B) are obtained by means of the light sensor 112 of the model LCP in step S408. The predetermined values L(R), L(G) and L(B) can be recorded into another LCP (e.g. the mass-produced LCP 200 in the FIG. 2) for performing the AWB method of FIG. 3.

In the present embodiment, the AWB method in the LCP 200 is executed while the LCP 200 is turned on at beginning. In another embodiment, the AWB method in the LCP 200 can be executed while the LCP 200 works.

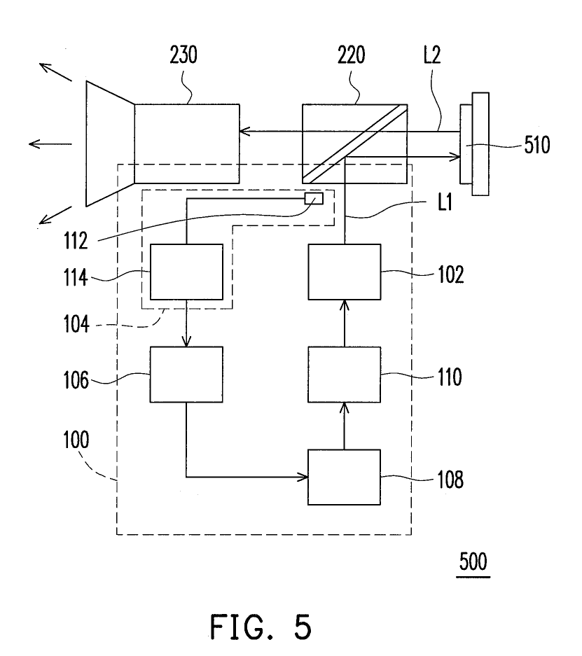

FIG. 5 illustrates a LCP with the AWB system of FIG. 1. according to one exemplary embodiment consistent with the present invention. Referring to FIG. 5, the LCP 500 of the present embodiment is similar to the LCP 200 as shown in FIG. 2, instead of the light sensor 112 disposed near the LED luminaire 102. As a result, the intensity of the three beams L′(R), L′(G), and L′(B) are respectively measured by the light sensor 112 before the micro display panel 510 reflects the beams to the projection lens 530 through the TIR prism 520. Since the light sensor 112 is disposed near the LED luminaire 102, it is possible that the AWB method in the LCP 500 is executed even if the micro display panel 510 has no white input pattern. Accordingly, the AWB method in the LCP 500 can be executed while the LCP 500 works. The white balance of the LCP 500 achieved by using the AWB method of the AWB system has been described above, and it is not described again herein.

To sum up, the AWB system with the light sensor according to one exemplary embodiment consistent with the present invention is different from the conventional system with three color sensors. That is, with the light sensor instead of the color sensors, the white balance of the color beams in the LCP with the AWB system is achieved. By regulating the driving current and the duty ratio, the intensity of the color beams measured by the light sensor is consistent with the predetermined values, no matter what colors of the beams are. The LCP with the AWB system utilizing the light sensor to achieve the purpose of the white balance has lower coat than the conventional LCP having three color sensors. Therefore, the cost of the projection apparatus with the AWB system is reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is clamed is:

1. An automatic white balance (AWB) system, comprising:
a luminaire, for sequentially providing a plurality of color lights, wherein the color lights comprises a first color light and a second color light;
a light sensing unit, for sensing intensity of the color lights emitted from the luminaire, and outputting a first analog signal and a second analog signal, which are corresponding to the first and the second color lights, respectively;
an analog-to-digital converter (A/D converter), coupled to the light sensing unit, for converting the first and the second analog signals to a first and a second digital signals, respectively;
a control unit, coupled to the A/D converter, for estimating a first offset of the first color light and a second offset of the second color light from a ratio of a first predetermine value and a second predetermine value, wherein the first and the second predetermine value are respectively corresponding to the first and the second color lights; and
a driving circuit, coupled to the control unit, for driving the luminaire in response to the first and the second offsets to achieve AWB of the color lights.

2. The AWB system as claimed in claim 1, wherein the light sensing unit comprises:
a light sensor, for sensing intensity of the color lights emitted from the luminaire; and
a light sensing circuit, coupled to the light sensor and the A/D converter, for outputting the first analog signal and the second analog signal, which are corresponding to the first and the second color lights, respectively.

3. The AWB system as claimed in claim 1, wherein the luminaire provides maximum intensity of the color lights for the light sensing unit.

4. The AWB system as claimed in claim 1, wherein the control unit estimates the two offsets from a equation
$$\frac{L ( 1 )}{{L}^{′} ( 1 ) - {a}_{1} {L}^{′} ( 1 )} = \frac{L ( 2 )}{{L}^{′} ( 2 ) - {a}_{2} {L}^{′} ( 2 )} ,$$
wherein L(1) is the first predetermine value, L(2) is the second predetermine value, L (1) is a first sensing value corresponding to the first color light, L′(2) is a second sensing value corresponding to the second color light, α₁L′(1) is the first offset and α₂L′(2) is the second offset.

5. The AWB system as claimed in claim 4, wherein a ratio of the first sensing value and the second sensing value is modified and equal to the ratio of the first predetermine value and the second predetermine value, and the control unit controls the driving circuit to drive the luminaire in response to a modified ratio of the first sensing value and the second sensing value.

6. The AWB system as claimed in claim 1, wherein the color lights further comprises a third color light, and the control unit estimates a third offset of the third color light from a ratio of the first predetermine value and a third predetermine value, and the driving circuit drives the luminaire in response to the first, the second, and the third offsets to achieve AWB of the color lights, wherein the third predetermine value is corresponding to the third color light.

7. The AWB system as claimed in claim 6, wherein the luminaire provides maximum intensity of the three color lights for the light sensing unit.

8. The AWB system as claimed in claim 6, wherein the control unit estimates the three offsets from a equation
$$\frac{L ( 1 )}{{L}^{′} ( 1 ) - {a}_{1} {L}^{′} ( 1 )} = \frac{L ( 2 )}{{L}^{′} ( 2 ) - {a}_{2} {L}^{′} ( 2 )} = \frac{L ( 3 )}{{L}^{′} ( 3 ) - {a}_{3} {L}^{′} ( 3 )} ,$$
wherein L(1) is the first predetermine value, L(2) is the second predetermine value, L(3) is the third predetermine value, L′(1) is a first sensing value corresponding to the first color light, L′(2) is a second sensing value corresponding to the second color light, L′(3) is a third sensing value corresponding to the third color light, α₁L′(1) is the first offset, α₂L′(2) is the second offset and α₃L′(3) is the third offset.

9. The AWB system as claimed in claim 6, wherein a continued ratio of the first sensing value, the second sensing value, and the third sensing value is modified and equal to the continued ratio of the first predetermine value, the second predetermine value, and the third predetermine value, and the control unit controls the driving circuit to drive the luminaire in response to the modified ratio.

10. The AWB system as claimed in claim 6, wherein the first, the second and the third color lights are respectively a red light, a green light and a blue light.

11. An automatic white balance (AWB) method, comprising:
providing a plurality of color lights by a luminaire, wherein the color lights comprises a first color light and a second color light;
sensing the color lights through a light sensing unit for obtaining a first analog signal corresponding to the first color light and a second analog signal corresponding to the second color light;
converting the first and the second analog signals to a first and a second digital signals, respectively, through an A/D converter;
estimating a first offset of the first color light and a second offset of the second color light from a ratio of a first predetermine value and a second predetermine value through a control unit, wherein the first and the second predetermine value are respectively corresponding to the first and the second color lights; and
driving the luminaire in response to the first and the second offsets through a driving circuit to achieve AWB of the first and the second color lights.

12. The AWB method as claimed in claim 11, wherein the intensity of the first and the second color lights in the step of providing the color lights for the light sensing unit are maximum.

13. The AWB method as claimed in claim 11, wherein in the step of estimating the first and the second offsets through the control unit, estimating the two offsets from a equation
$$\frac{L ( 1 )}{{L}^{′} ( 1 ) - {a}_{1} {L}^{′} ( 1 )} = \frac{L ( 2 )}{{L}^{′} ( 2 ) - {a}_{2} {L}^{′} ( 2 )} ,$$
wherein L(1) is the first predetermine value, L(2) is the second predetermine value, L′(1) is a first sensing value corresponding to the first color light, L′(2) is a second sensing value corresponding to the second color light, α₁L′(1) is the first offset and α₂L′(2) is the second offset.

14. The AWB method as claimed in claim 13, wherein in the step of estimating the first and the second offsets through the control unit, modifying a ratio of the first sensing value and the second sensing value equal to the ratio of the first predetermine value and the second predetermine value.

15. The AWB method as claimed in claim 13, wherein in the step of driving the luminaire, controlling the driving circuit through the control unit to drive the luminaire in response to the modified ratio.

16. The AWB method as claimed in claim 11, wherein in the step of providing the color lights, providing a third color light, and estimating a third offset of the third color light from a ratio of the first predetermine value and a third predetermine value in the step of estimating the first and the second offsets through the control unit, and driving the luminaire in response to the first, the second and the third offsets to achieve AWB of the first, the second and the third color lights through the driving circuit in the step of driving the luminaire, wherein the third predetermine value is corresponding to the third color light.

17. The AWB method as claimed in claim 16, wherein the intensity of the first, the second and the third color lights in the step of providing the color lights for the light sensing unit are maximum.

18. The AWB method as claimed in claim 16, wherein in the step of estimating the three offsets through the control unit, estimating the first, the second and the third offsets from a equation
$$\frac{L ( 1 )}{{L}^{′} ( 1 ) - {a}_{1} {L}^{′} ( 1 )} = \frac{L ( 2 )}{{L}^{′} ( 2 ) - {a}_{2} {L}^{′} ( 2 )} = \frac{L ( 3 )}{{L}^{′} ( 3 ) - {a}_{3} {L}^{′} ( 3 )} ,$$
wherein L(1) is the first predetermine value, L(2) is the second predetermine value, L(3) is the third predetermine value, L′(1) is a first sensing value corresponding to the first color light, L′(2) is a second sensing value corresponding to the second color light, L′(3) is a third sensing value corresponding to the third color light, α₁L′(1) is the first offset, α₂L′(2) is the second offset and α₃L′ (3) is the third offset.

19. The AWB method as claimed in claim 16, wherein in the step of estimating the first, the second and the third offsets through the control unit, modifying a continued ratio of the first sensing value, the second sensing value, and the third sensing value equal to the continued ratio of the first predetermine value, the second predetermine value, and the third predetermine value.

20. The AWB method as claimed in claim 19, wherein in the step of driving the luminaire, controlling the driving circuit through the control unit to drive the luminaire in response to the modified ratio.
